(19) United States
(12) Patent Application Publication
(10) Pub. No.: US 2008/0236345 A1
(43) Pub. Date: Oct. 2, 2008

(54) Interengaged multiple-drip set of pliers

(76) Inventors: Frederic Bocquet, Voray Sur L'Ognon (FR); Guy Siruguet, Savigny Sur Orge (FR)

Correspondence Address: WENDEROTH, LIND & PONACK, L.L.P., 2033 K STREET N. W., SUITE 800, WASHINGTON, DC, 20006-1021, US

(21) Appl. No.: 12/007,446

(22) Filed: Jan. 10, 2008

(30) Foreign Application Priority Data
Jan. 11, 2007 (FR) 07 00208

(51) Int. Cl. B25B 7/04

(52) U.S. Cl. 81/411

(57) ABSTRACT

The interengaged multiple-grip set of pliers comprises an interengaging arm, an interengaged arm, and an articulation joint, one arm comprising an elongate opening which is provided with first engagement means having a pitch p, the joint being arranged on the other arm and having second engagement means, the joint being axially movable between a first position blocking any translation between the arms, and a second axial position allowing translation.

The first engagement means and second engagement means are arranged in such a manner that, starting from a first engagement position between the first engagement means and second engagement means, the joint is axially movable beyond the second axial position as far as a third axial position, and can then be moved in rotation about the axis thereof in order to bring the first and second engagement means into engagement in a second engagement position allowing, owing to distances which are equal to a predetermined fraction of the pitch p, the position of the joint in the opening to be adjusted.

### BACKGROUND OF THE INVENTION

The present invention relates to an interengaged multiple-grip set of pliers which extends in a general plane, of the type comprising:

an interengaging arm which comprises a first jaw, a first intermediate articulation region and a first handle, which interengaging arm has a longitudinal slot in the first articulation region;
an interengaged arm which comprises a second jaw, a second intermediate articulation region and a second handle, the second articulation region being received, so as to be movable in rotation and selectively in translation, through the longitudinal slot of the first articulation region; and
an articulation joint which is provided in order to articulate the interengaging arm and the interengaged arm, one of the arms comprising an elongate opening along an axis in the general plane of the set of pliers, which opening is provided with two longitudinal sides, comprising first engagement means having a pitch p,
the joint being arranged on the other arm and comprising a member having second engagement means which are capable of cooperating, by means of shape adjustment, with the first engagement means, which member extends along an axis Z-Z which is substantially perpendicular to the axis of the opening,
the member of the joint being movable axially in accordance with the axis Z-Z thereof at least between a first axial position and a second axial position, the first axial position bringing the first and second engagement means into engagement and thereby blocking any relative translation movement between the interengaging arm and the interengaged arm, and the second position corresponding to the mutual disengagement of the first and second engagement means and thereby allowing relative translation movement between the interengaging arm and the interengaged arm.

It is known, in the field of hand tools, to use interengaged multiple-grip sets of pliers which allow the opening of the jaws to be adjusted by pushing an articulation joint axially from a first axial position towards a second axial position and then by means of relative translation of the arms with respect to each other.

In EP-A-528252, the interengaging arm of the interengaged set of pliers comprises an articulation joint comprising two symmetrical toothed profiles which complement the profiled sides of an opening, whose axis is arranged substantially longitudinally on the interengaged arm of the multiple-grip set of pliers.

However, using that multiple-grip set of pliers does not allow precise adjustment of the opening of the jaws. Furthermore, that interengaged set of pliers does not allow ergonomic adjustment of the spacing of the handles in accordance with the size of the hand of the user.

### SUMMARY OF THE INVENTION

According to one aspect, an object of the invention is to provide an interengaged multiple-grip set of pliers which can be adjusted precisely in terms of the spacing of the handles and/or the jaws. To that end, the invention relates to an interengaged multiple-grip set of pliers of the above-mentioned type whose first and second engagement means are arranged in such a manner that, starting from a first engagement position in accordance with the axis of the opening between the first and second engagement means, the member of the joint is axially movable beyond the second axial position as far as a third axial position, and can then be moved in rotation about the axis Z-Z thereof in order to bring the first and second engagement means into engagement in a second engagement position in accordance with the axis of the opening allowing, owing to distances which are equal to a predetermined fraction of the pitch p, the position of the member in the opening to be adjusted.

According to other features:

the first engagement means comprise, on each of the two longitudinal sides of the opening, a series of successive peaks which are separated by troughs, the series being identical and longitudinally displaced relative to each other in such a manner that a peak of one series faces a trough of the other series, and the second engagement means comprise at least two series of teeth having a profile which complements that of the first engagement means, the second engagement means being capable of carrying out a rotation relative to the axis Z-Z of the member of the joint, once the first engagement means and the second engagement means have been mutually disengaged, and of moving back into mutual engagement after that rotation;

the second engagement means comprise two series of teeth which are opposite and displaced relative to each other by a half-pitch p, and are capable of carrying out a rotation through 180° in the third axial position;

the interengaging arm comprises a partition at one side and the other of the longitudinal slot, in one of which partitions there is arranged an opening which is intended to guide the articulation joint, and the interengaged arm comprises the elongate opening;

the successive peaks and troughs are of identical shape and size and are provided in accordance with a constant pitch p;

the articulation joint comprises a member which is intended to support a thrust effort, in particular a cover;

the thrust member comprises a reference marking for the angular position thereof;

the partition of the interengaging arm comprising a receiving recess which is adjacent to the thrust member comprises a plurality of differentiated markings, in particular two markings which are diametrically opposite with respect to the articulation joint;

by the member of the articulation joint being rotated, the reference marking of the thrust member faces one of the markings of the interengaging arm;

the articulation joint comprises gripping notches which are provided opposite the thrust member;

the interengaged arm has a quasi-constant thickness over the majority of the length thereof and as far as the end opposite the jaw thereof;

at least one end-plate is applied to the handle of the interengaged arm, in particular two end-plates, the or each end-plate being applied to a side of the handle of the interengaged arm;

the articulation joint further comprises a shaft which extends along the axis Z-Z of the member of the joint, relative to which shaft the interengaging arm pivots, with the shaft being laterally displaced by d relative to the axis of the elongate opening.

According to another aspect, an object of the invention is to reduce the shear stresses of the articulation joint. This problem is solved in that, in an interengaged multiple-grip set of pliers of the type set out above, the second engagement means comprise two series of teeth which are opposed and displaced relative to each other by a half-pitch p, and are capable of carrying out a rotation through 180° in the third axial position.

In this manner, the opening has profiled sides which are asymmetrical relative to the axis of the opening and whose spacing is constant.

According to another aspect, an object of the invention is to facilitate the assembly of the interengaged arm in the longitudinal opening of the interengaging arm.

This problem is solved in that, in an interengaged multiple-grip set of pliers of the type set out above, the interengaged arm has a quasi-constant thickness over the majority of the length thereof and as far as the end opposite the jaw thereof.

In greater detail, there is provision for applying at least one end-plate in order to increase the thickness of the handle portion. In this manner, at least one end-plate is applied to the handle of the interengaged arm, in particular two end-plates, the or each end-plate being applied to one side of the handle of the interengaged arm.

### BRIEF DESCRIPTION OF THE DRAWINGS

The invention will now be described in a non-limiting manner with reference to the appended Figures, in which:

FIG. 1 is an exploded perspective view of the interengaged multiple-grip set of pliers according to the invention,

FIG. 2A is a front view of the set of pliers of FIG. 1, showing a position of the handles with reduced spacing,

FIG. 2B is a view similar to FIG. 2A showing increased spacing of the handles,

FIGS. 3A and 3B are front views, drawn to an enlarged scale, of the intermediate articulation regions of the multiple-grip set of pliers of FIGS. 2A and 2B, respectively,

FIGS. 4A and 4B are sectional views along the lines IVA-IVA and IVB-IVB of the multiple-grip sets of pliers of FIGS. 2A and 2B, respectively,

FIGS. 5A and 5B illustrate the steps for precise adjustment of the multiple-grip set of pliers of FIG. 1,

FIG. 6 is a top view, drawn to an enlarged scale, of the pinion of the articulation joint of the interengaged multiple-grip set of pliers of FIG. 1.

### DETAILED DESCRIPTION OF THE PREFERRED EMBODIMENT

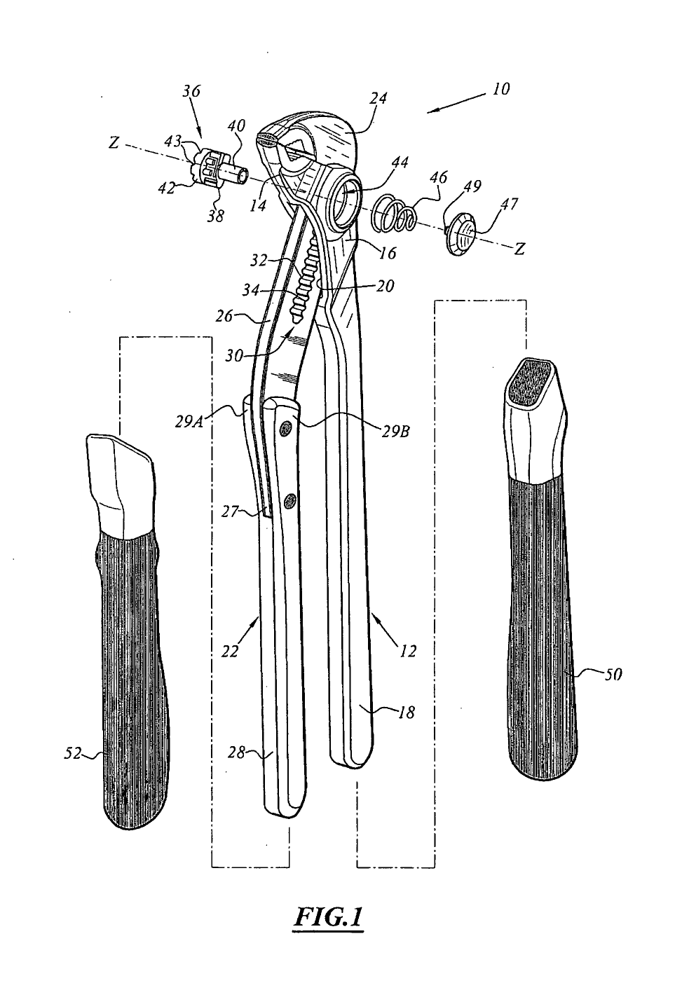

The tool of FIG. 1 is a multiple-grip set of pliers 10 which extends in a general plane. It is of the interengaged type and comprises an interengaging arm 12 which comprises a first jaw 14, a first intermediate articulation region 16 and a first handle 18. The interengaging arm 12 has a longitudinal opening 20 which is provided in the first articulation region 16. The set of pliers 10 also comprises an interengaged arm 22 which comprises a second jaw 24, a second intermediate articulation region 26 and a second handle 28. The second articulation region 26 is received so as to be movable in rotation and selectively in translation through the longitudinal opening 20 of the first articulation region 16.

In the example illustrated in FIG. 1, the interengaged arm 22 comprises a proximal portion 27 of a handle 28 that is reduced in terms of length. The interengaged arm 22 has a quasi-constant thickness over the majority of the length thereof, that is to say, from the second jaw 24 as far as the end of the proximal portion 27 of the handle 28, which allows the interengaged arm 22 to pass into the longitudinal opening 20 of the interengaging arm 12, the thickness of the second intermediate articulation region 26 of the interengaged arm 22 being calibrated, to within play tolerances, relative to the width of the longitudinal opening 20. When the set of pliers 10 is assembled, the proximal portion 27 of the handle 28 is introduced through the opening 20, two respective end-plates 29A and 29B are fitted and fixedly joined to that proximal portion 27 of the handle 28 by known means such as welding or riveting in order to form the first handle 28. That arrangement allows a reduction in play in the articulation region of each of the arms and improves the perception, by the user, of precise guiding of the arms of the set of pliers with respect to each other.

An elongate opening 30 extends along the longitudinal axis of the second intermediate articulation region 26. It is provided with two profiled longitudinal sides 32 and 34 which are substantially parallel.

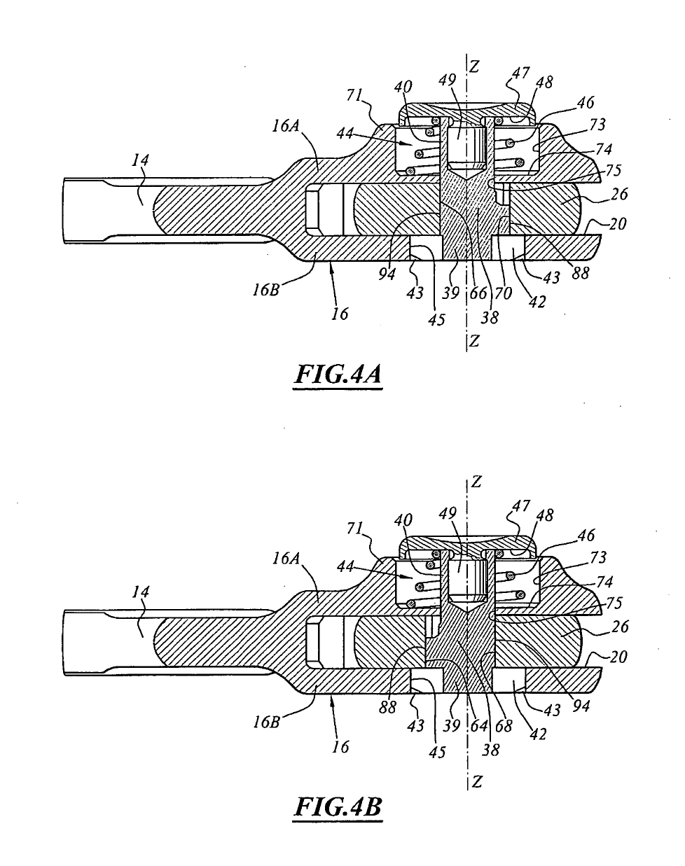

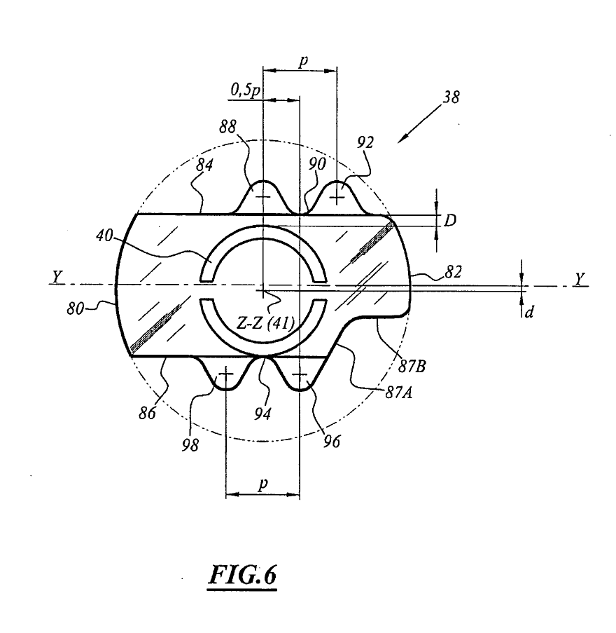

The set of pliers 10 further comprises an articulation joint 36 which extends along an axis Z-Z which is perpendicular to the general plane of the set of pliers. The joint 36 articulates the interengaging arm 12 and the interengaged arm 22. It comprises a member or pinion 38 which extends, in a first direction, by means of a protruding pin 39 (FIGS. 4A and 4B), and, in a second direction opposite the first direction of the pin 39, by means of a hollow shaft 40. The protruding pin 39 and the hollow shaft 40 have circular cross-sections with a centre 41 carried by the axis z-Z (FIG. 6), and they are integral with the pinion 38. A washer 42, which is also circular, is fixedly joined to the pinion 38 by means of force-fitting or snap-riveting onto the protruding pin 39.

In a variant which is not illustrated, the pinion 38 and the washer 42 are constructed in one piece, for example, by metal injection moulding (MIM).

The washer 42 comprises external notches 43 which improve the capacity for gripping. The pin 39, the hollow shaft 40 and the washer 42 are coaxial and are constructed by revolution about the axis Z-Z.

A recess 44 is arranged externally on a first partition 16A (FIGS. 4A and 4B) which laterally delimits the longitudinal opening 20 of the intermediate region 16 of the interengaging arm 12. A hole 45 (FIGS. 4A and 4B) is provided, opposite the recess 44, through the second partition 16B (FIGS. 4A and 4B) which is lateral with respect to the opening 20. The recess 44 and the hole 45 have circular cross-sections and are coaxial. The hole 45 has a shape complementary to the washer 42, to within play tolerances, and receives it so as to guide it in terms of rotation and translation. The recess 44 receives in abutment the widened end turn of a conical helical spring 46. The turn at the opposite end of the spring 46, having a reduced diameter, abuts against the internal face 48 (FIGS. 4A and 4B) of an abutment member 47 in the form of a cover. A pin 49 extends from the internal face 48 of the cover 47 and is fixedly joined to the hollow shaft 40 of the articulation joint 36 by resilient snap-fitting or force-fitting.

The interengaging arm 12 pivots about the articulation joint 36. The pinion 38 cooperates, by means of shape adjustment, with the profiled sides 32 and 34 of the opening 30 of the intermediate articulation region 26 of the arm 22.

Sheaths 50 and 52 cover the first handle 18 and the second handle 28, respectively.

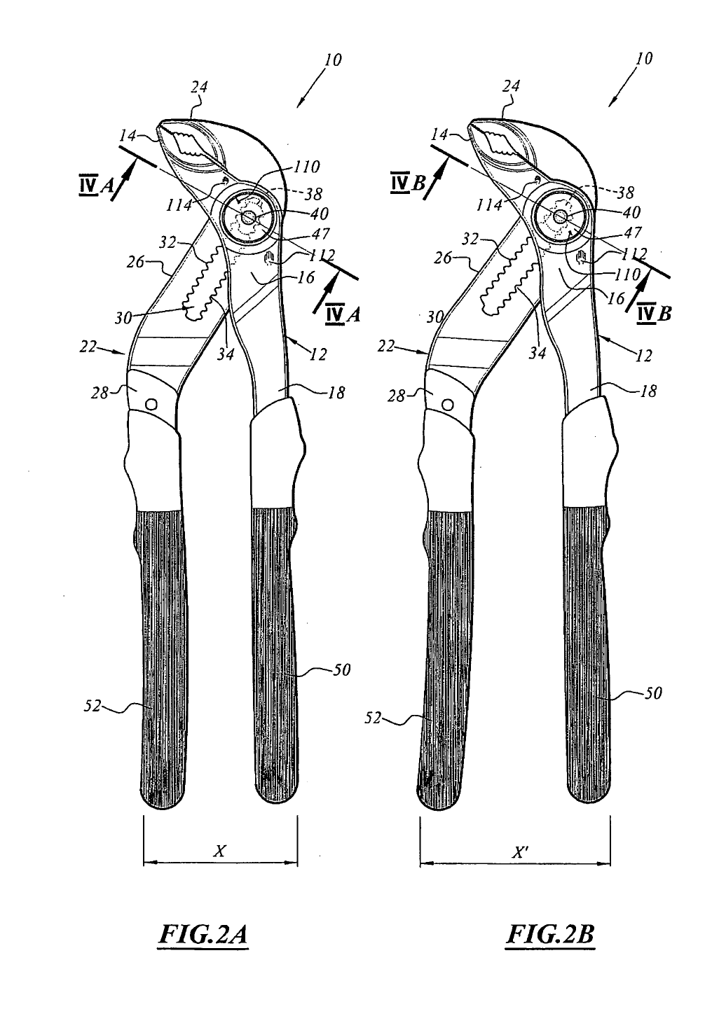

The FIGS. 2A and 2B illustrate the interengaged multiple-grip set of pliers 10 in two different configurations, in which, although the spacing of the first jaw 14 and the second jaw 24 is similar, that is to say, in the configurations illustrated, with zero spacing of the free ends of the jaws 14 and 24, the spacing of the first handle 18 and the second handle 28 is substantially different.

In this manner, the spacing X between the handles 18 and 28, measured half-way along the sheaths 50 and 52, is approximately 50 mm in the configuration of the set of pliers 10 illustrated in FIG. 2A, and the spacing X′ between the handles 18 and 28, measured under the same conditions, is approximately 58 mm in the configuration of the set of pliers 10 illustrated in FIG. 2B. Those spacings are measured for a set of pliers 10 having a total length of approximately 250 mm.

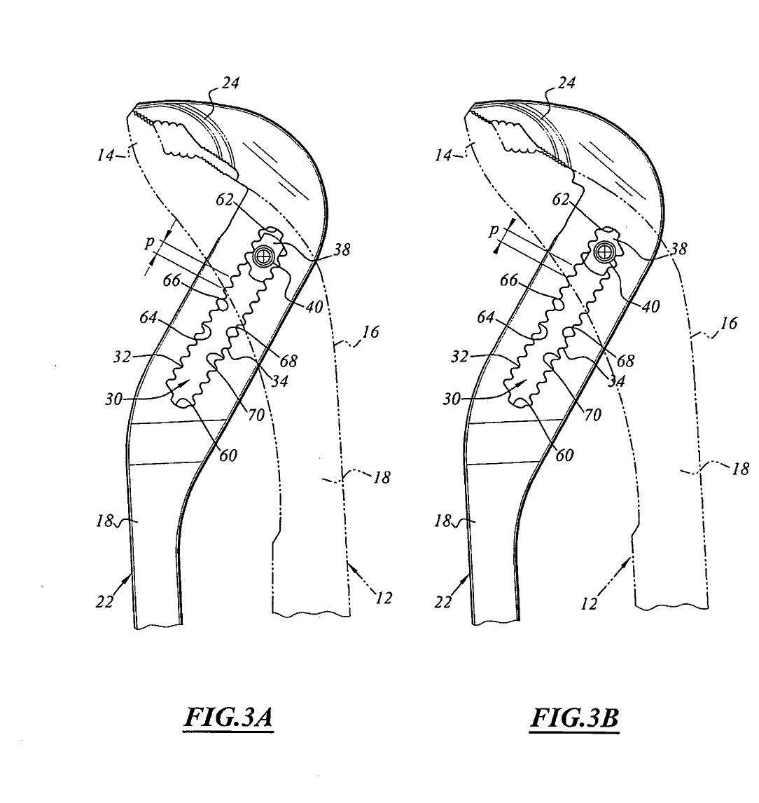

To that end, the pinion 38 which cooperates with the profiled sides 32 and 34 of the opening 30, is arranged axially in the opening 30 in two different positioning configurations along the longitudinal axis of the opening 30. They are illustrated in the FIGS. 3A and 3B, in which the interengaging arm 12 is illustrated as a dot-dash line for the sake of clarity of the drawings.

The elongate opening 30 is defined, at one side, by the longitudinal profiled sides 32 and 34 and, at the other side, by an end surface 60 arranged at the side of the handles 18 and 28 and by an end surface 62 arranged at the side of the jaws 14 and 24.

In FIGS. 3A and 3B, the profiled sides 32 and 34 of the opening 30 each have a wave-like shape of pitch p, alternating between troughs and peaks of constant dimensions. The profiled side 32 is arranged at the side of the jaws 14 and 24 of the set of pliers 10 and thus comprises, in an alternating manner, troughs 64 and peaks 66. Similarly, the profiled side 34 which is arranged at the side of the handles 18 and 28 has, in an alternating manner, peaks 68 and troughs 70 having the same dimensions as the troughs 64 and peaks 66 of the profiled side 32. It should be noted that the pitch p of the wave is constant and identical over the profiled sides 32 and 34. It should also be noted that peaks and troughs have rounded shapes. The arrangement of the troughs 64 and the peaks 66 of the profiled side 32 and that of the peaks 68 and the troughs 70 of the profiled side 34 are such that a trough 64 of the profiled side 32 faces a peak 68 of the profiled side 34. Similarly, a peak 66 of the profiled side 32 faces a trough 70 of the profiled side 34.

In this manner, the opening 30 does not have, as in the prior art, two symmetrical profiled sides which together comprise, in an alternating manner, narrowed portions and widened portions. Instead, the profiled sides 32 and 34 are displaced by a half-pitch p along the axis of the opening 30 in such a manner that they have a constant spacing between the troughs and the peaks along the entire length of that opening, which contributes to an improvement in the shear-resistance of the members of the articulation regions of the set of pliers.

As illustrated in FIG. 6, the member or pinion 38 also extends along an axis Y-Y which is perpendicular to the axis Z-Z. The axis Y-Y coincides with the axis of the elongate opening 30 of the interengaged arm 22 when the member or pinion 38 is assembled in the opening 30. The member or pinion 38 is delimited by a first arcuate end face 80 which is centred on the location 41 and whose radius is equal to that of the washer 42. It is delimited, opposite the first end face 80, by a second arcuate end face 82, which is centred on the location 41 and which has a radius equal to that of the washer 42. The centre 41 of the end faces 80 and 82 is displaced laterally by a distance d relative to the axis Y-Y of the pinion 38 and the chord of the end face 82 is less than that of the end face 80.

The end face 82 of the pinion 38 has a shape which complements those of the end faces 60 and 62 of the opening 30.

The pinion 38 is also delimited by two flattened planar faces 84 and 86 which extend at one side and the other of the hollow shaft 40. The flattened faces 84 and 86 are parallel and spaced apart by a dimension which is slightly less than that between the peaks of the profiled sides 32 and 34 of the opening 30. The flattened face 84, which is long, connects the end faces 80 and 82. The flattened face 86, which is shorter than the face 84, joins the end face 80 and extends over approximately two-thirds in the direction of the end face 82. It joins an oblique face 87A which is directed towards the axis Y-Y of the pinion 38 and which itself joins a face 87B which is substantially parallel with the face 86. The face 87B joins the end face 82. The pinion 38 thus has an asymmetrical contour which acts as a device to promote correct assembly of the set of pliers.

It should be noted that the hollow shaft 40 is not arranged symmetrically relative to the planar faces 84 and 86. It has a displacement D, which is equal to 2d, of approximately 0.5 mm relative to the surface 84 which directly connects the end surfaces 80 and 82 and the advantage of which will be described below. The external surface of the hollow shaft 40 which is diametrically opposed to the face 84 is aligned with the planar surface 86.

The pinion 38 further comprises, on each of the flattened planar faces 84 and 86, a series of troughs and peaks of wave-like shape which complements that of the troughs and peaks of the profiled sides 32 and 34 of the opening 30.

The flattened planar face 84 has, over more than two-thirds of the height of the face, facing the centre 41 of the hollow shaft 40, a peak 88 which is followed, in the direction of the arcuate end face 82, by a trough 90 whose base is arranged in the plane of the face 84, which trough is followed, in the direction of the arcuate displaced end face 82, by a second peak 92 which joins the end face 82.

The flattened face 86, opposite the preceding face 84, has, over more than two-thirds of the height of the face, facing the centre 41 of the hollow shaft 40, a trough 94 whose base is arranged in the plane of the flattened surface 86. In the direction of the end face 82, the trough 94 is followed by a peak 96 which itself joins the oblique surface 87A. In the direction of the curved end surface 80, the trough 94 is extended by a peak 98, that peak joining the flattened face 86.

In this manner, two series of troughs and peaks are arranged at one side and the other of the hollow shaft 40 and are provided in such a manner that the peak 88 arranged on the long face 84 faces a trough 94 arranged on the face 86. Similarly, the trough 90, which is arranged on the long face 84, faces the peak 96 arranged on the short face 86, the peak 92 of the long face 84 is arranged substantially facing the oblique face 87A, and the peak 98 of the short face 86 is arranged facing the zone for connecting the peak 88 of the long face 84 thereto.

In FIG. 3A, the orientation of the pinion 38 is such that the short face 86 is directed towards the jaws 14 and 24, whilst the long face 84 is directed towards the handles 18 and 28. In this configuration, the end face 80 of the pinion 38 is located spaced-apart from the end face 62 of the opening 30 which is positioned at the side of the jaws 14 and 24. The pinion 38 is blocked, along the longitudinal axis of the opening 30, in a position preceding the extreme position at the side of the jaws 14 and 24. The hollow shaft 40 is displaced at the side of the jaws 14 and 24 relative to the longitudinal axis of the opening 30.

In FIG. 3B, the orientation of the pinion 38 is transposed: the long face 84 is directed towards the jaws 14 and 24, whilst the short face 86 is directed towards the handles 18 and 28. In this configuration, the end face 82 of the pinion 38 is subjected to shape adjustment with the end face 62 of the opening 30 positioned at the side of the jaws 14 and 24. That arrangement allows the pinion 38 to access, along the longitudinal axis of the opening 30, the extreme axial position at the side of the jaws 14 and 24. The hollow shaft 40 is displaced at the side of the handles 18 and 28 relative to the longitudinal axis of the opening 30.

Consequently, in FIG. 3A, the intermediate articulation region 16 of the interengaging arm 12 tends to move towards the handle 28 of the interengaged arm 22, and in FIG. 3B, the intermediate articulation region 16 of the interengaging arm 12 tends to move away from the handle 28 of the interengaged arm 22.

Taking into consideration the displacement of the series of peaks and troughs present, both on the profiled sides 32 and 34 and on the flattened faces 84 and 86 of the pinion 38, the pinion 38 can be moved in the axial direction of the opening 30 by a fraction of a pitch p, in particular, in the example illustrated, by a half-pitch p, towards the end face 62 arranged at the side of the jaws 14 and 24. It is thereby advantageous to obtain, with a constant dimension in terms of the jaws 14 and 24, variable spacing in terms of the handles 18 and 28. In the same manner as before, with constant spacing of the handles 18 and 28, it is advantageous to be able to adjust, to within a fraction of a pitch p, the spacing between the jaws 14 and 24.

It should be noted that the lateral displacement D of the hollow shaft 40 relative to the long guiding surface 84 and the displacement d=D/2 relative to the axis 41 allow the free ends of the jaws 14 and 24 to be aligned substantially in the same plane when the pinion 38 is rotated through 180°.

This arrangement is advantageous in order to improve the gripping of objects at the end of the jaws, whatever the configuration of the set of pliers.

As illustrated in FIGS. 4A and 4B, the recess 44 is obtained from a collar 71 which projects from the partition 16A of the intermediate articulation region 16. The recess 44 is in the form of a hole comprising a circular lateral surface 73 and a base 74, against which the spring 46 abuts. An opening 75 is provided in the base 74 in order to receive the hollow shaft 40, to within play tolerances, and to guide it in terms of rotation and translation in accordance with the axis Z-Z.

In FIG. 4A, the peak 66 of the profiled side 32 is in engagement with the trough 94 of the short flattened face 86 of the pinion 38. Diametrically opposite the hollow shaft 40, the peak 88 of the long flattened face 84 of the pinion 38 is in engagement with a trough 70 of the profiled side 34 of the opening 30.

In FIG. 4B, the same peak 88 of the long flattened face 84 of the pinion 38 is in engagement with a trough 64 of the profiled side 32 of the opening 30. Diametrically opposite the hollow shaft 40, the trough 94 of the short flattened face 86 of the pinion 38 is in engagement with a peak 68 of the profiled side 34 of the opening 30.

There will now be described the steps allowing the pinion 38 to move successively from its configuration illustrated in FIG. 4A to the configuration illustrated in FIG. 4B.

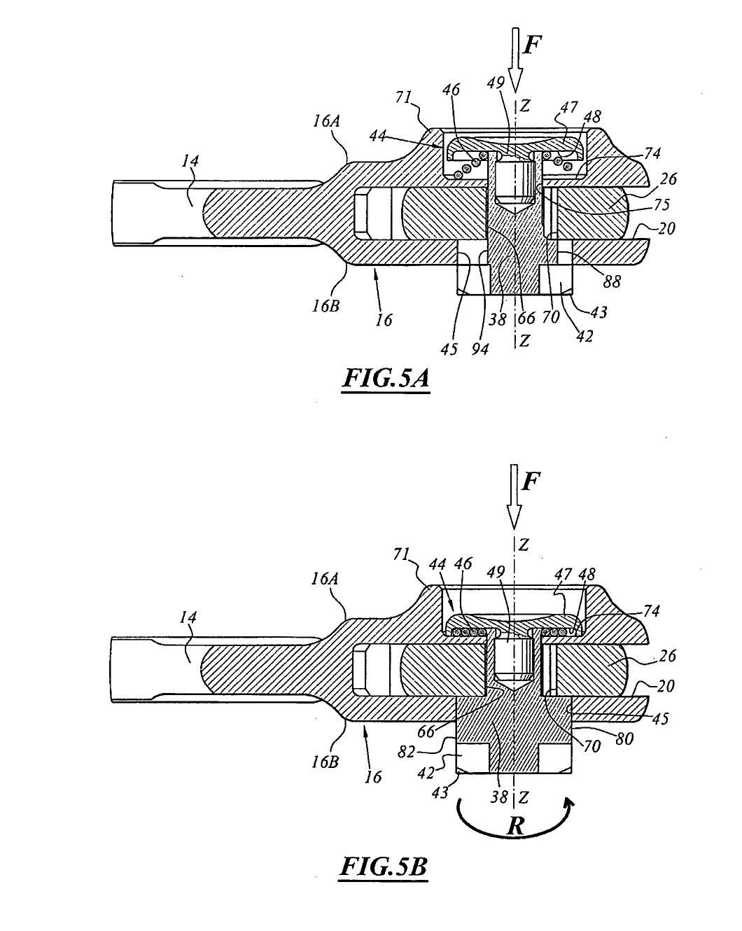

In its configuration illustrated in FIG. 4A, the pinion 38 and the profiled sides 32 and 34 of the opening 30 are mutually engaged, the pinion 38 occupying a first axial position which is perpendicular to the general plane of the set of pliers, and in which the cover 47 projects out of the recess 44. By pressing on the cover 47 in accordance with the arrow F illustrated in FIG. 5A and tending to move the cover 47 to a position approximately half-way down the recess 44, the user displaces the pinion 38′ in such a manner that the means for engaging the pinion 38 and those of the profiled sides 32 and 34 of the opening 30 become mutually disengaged. The pinion 38 occupies a second axial position, which is perpendicular to the general plane of the set of pliers, illustrated in FIG. 5A. The engagement means of the pinion 38 are located facing the hole 45 which is formed in the partition 16B of the intermediate articulation region 16 of the interengaging arm 12. It should be noted that the guiding in terms of translation is brought about, on the one hand, by the external surface of the hollow shaft 40 cooperating with the internal surface of the opening 75 and, on the other hand, by the external surfaces of the washer 42 and the arcuate end faces 80 and 82 of the pinion 38 cooperating with the internal surface of the hole 45.

In this second axial position of the pinion 38, perpendicular to the general plane of the set of pliers, the complementary nature of the height of the flattened faces 84 and 86, excluding the peaks and troughs, allows the pinion 38 to be guided in translation in the axial direction of the opening 30 between the peaks of the profiled sides 32 and 34 of the opening 30.

By continuing to push on the cover 47 in accordance with the arrow F illustrated in FIG. 5B, the user substantially positions the cover 47 in abutment against the base 74 of the recess 44, compressing to a maximum the conical spring 46 between that base 74 and the internal face 48 of the cover 47.

In this new axial position, perpendicular to the general plane of the set of pliers, the arcuate end faces 80 and 82 of the pinion 38 are arranged facing the internal surface of the hole 45. The user, whilst maintaining the pressure which tends to cause the cover 47 to abut the base 74 of the recess 44, manipulates the washer 42 which is fixedly joined to the pinion 38 in such a manner as to rotate the pinion 38 through a half-turn relative to the axis Z-Z. In FIG. 5B, the rotation is underway and represents approximately 90°, the curved end faces 80, 82 of the pinion 38 acting as a guide in terms of rotation in the hole 45.

Once the rotation through 180° relative to the axis Z-Z has been carried out, the user relaxes the pressure on the cover 47, which tends to move the engagement means of the pinion 38 and those of the profiled sides 32 and 34 of the opening 30 closer to each other. The user manually carries out a displacement through a half-pitch p, tending to align the engagement means of the pinion 38 and those of the profiled sides 32 and 34 of the opening 30. With the pressure on the cover 47 being completely relaxed, the user mutually engages, by means of shape adjustment, the engagement means of the pinion 38 and those of the profiled sides 32 and 34 of the opening 30.

In this manner, the number of adjustment positions of the pinion 38 in accordance with the longitudinal axis of the opening 30 is doubled with respect to a conventional set of pliers, because, based on an initial adjustment position of the pinion 38, there is provided an adjustment position at a half-pitch p at one side and the other of the initial position simply by rotating the pinion through 180° about the axis Z-Z.

As illustrated in FIGS. 2A and 2B, in order to facilitate the reference system for orientating the pinion 38 for the user, a marking 110 such as an arrow which is orientated radially outwardly, is positioned on the external face of the cover 47 in a visible manner. The reference marking 110 allows the angular positioning of the cover 47 relative to the axis Z-Z. Differentiated markings 112 and 114 are arranged so as to be diametrically opposite the circular recess 44. The first differentiated marking 112, such as a hand, is positioned, at the side of the handle 18 and in a visible manner, on the external face of the partition 16A of the intermediate articulation region 16 of the interengaging arm 12. A second differentiated marking which has smaller dimensions than the first marking, such as a hand, is positioned, on the same external face of the partition 16A, at the side of the jaw 14 of the interengaging arm 12. In this manner, it is easy for the user to position the pinion 38 in one of the configurations leading to greater or lesser spacing of the handles 18 and 28 of the set of pliers.

The preceding description has been given within the context of the adjustment of the spacing of the handles of an interengaged multiple-position set of pliers, with constant spacing in terms of the jaws of the same set of pliers. It is apparent that the device described above is advantageous for adjusting the spacing of the jaws of a set of pliers, with constant spacing in terms of the handles of the same set of pliers. That facilitates the repetitive use of the tool.

Such a set of multiple-grip pliers allows gripping, in terms of the jaws, of heads of screwed fixing elements both with metric dimensions and with imperial dimensions.

The preceding description has been given within the context of an adjustment of the position of the pinion 38 in the opening 30 to within a half-pitch p, by means of a rotation of the pinion 38 through 1800. Therefore, the device described is advantageous for adjusting the position of the pinion 38 in the opening 30 to within a fraction of the pitch p, by means of a rotation of the pinion 38 through a fraction of 360°, the fractions being equal.

Owing to the invention, it is possible to adjust precisely the spacing of the handles of a set of pliers and/or the spacing of the jaws of that set of pliers.

1. Interengaged multiple-grip set of pliers which extends in a general plane, of the type comprising:
an interengaging arm which comprises a first jaw, a first intermediate articulation region and a first handle, which interengaging arm has a longitudinal slot in the first articulation region;
an interengaged arm which comprises a second jaw, a second intermediate articulation region and a second handle, the second articulation region being received, so as to be movable in rotation and selectively in translation, through the longitudinal slot of the first articulation region; and
an articulation joint which is provided in order to articulate the interengaging arm and the interengaged arm,
one of the arms comprising an elongate opening along an axis in the general plane of the set of pliers, which opening is provided with two longitudinal sides comprising first engagement means having a pitch,
the joint being arranged on the other arm and comprising a member having second engagement means which are capable of cooperating, by means of shape adjustment, with the first engagement means, which member extends along an axis which is substantially perpendicular to the axis of the opening,
the member of the joint being movable axially in accordance with the axis thereof at least between a first axial position and a second axial position, the first axial position bringing the first engagement means and second engagement means into engagement and thereby blocking any relative translation movement between the interengaging arm and the interengaged arm, and the second position corresponding to the mutual disengagement of the first engagement means and second engagement means and thereby allowing relative translation movement between the interengaging arm, and the interengaged arm,
wherein the first engagement means and second engagement means are arranged in such a manner that, starting from a first engagement position in accordance with the axis of the opening between the first engagement means and second engagement means, the member of the joint is axially movable beyond the second axial position as far as a third axial position, and can then be moved in rotation about the axis thereof in order to bring the first and second engagement means into engagement in a second engagement position in accordance with the axis of the opening allowing, owing to distances which are equal to a predetermined fraction of the pitch, the position of the member in the opening to be adjusted.

2. Interengaged multiple-grip set of pliers according to claim 1, wherein the first engagement means comprise, on each of the two longitudinal sides of the opening, a series of successive peaks which are separated by troughs, the series being identical and longitudinally displaced relative to each other in such a manner that a peak of one series faces a trough of the other series, and the second engagement means comprise at least two series of teeth having a profile which complements that of the first engagement means, the second engagement means being capable of carrying out a rotation relative to the axis of the member of the joint, once the first engagement means and the second engagement means have been mutually disengaged, and of moving back into mutual engagement after that rotation.

3. Interengaged multiple-grip set of pliers according to claim 1, wherein the second engagement means comprise two series of teeth which are opposite and displaced relative to each other by a half-pitch and are capable of carrying out a rotation through 180° in the third axial position.

4. Interengaged multiple-grip set of pliers according to claim 1, wherein the interengaging arm comprises a partition at one side and the other of the longitudinal slot, in one of which partitions there is arranged an opening which is intended to guide the articulation joint, and the interengaged arm comprises the elongate opening.

5. Interengaged multiple-grip set of pliers according to claim 2, wherein the successive peaks and troughs are of identical shape and size and are provided in accordance with a constant pitch.

6. Interengaged multiple-grip set of pliers according to claim 1, wherein the articulation joint comprises a member which is intended to support a thrust effort, in particular a cover.

7. Interengaged multiple-grip set of pliers according to claim 6, wherein the thrust member comprises a reference marking for the angular position thereof.

8. Interengaged multiple-grip set of pliers according to claim 6, wherein the partition of the interengaging arm comprising a receiving recess which is adjacent to the thrust member comprises a plurality of differentiated markings, in particular two markings which are diametrically opposite with respect to the articulation joint.

9. Interengaged multiple-grip set of pliers according to claim 7, wherein, by the member of the articulation joint being rotated, the reference marking of the thrust member faces one of the markings of the interengaging arm.

10. Interengaged multiple-grip set of pliers according to claim 5, wherein the articulation joint comprises gripping notches which are provided opposite the thrust member.

11. Interengaged multiple-grip set of pliers according to claim 1, wherein the interengaged arm has a quasi-constant thickness over the majority of the length thereof and as far as the end opposite the jaw thereof.

12. Interengaged multiple-grip set of pliers according to claim 1, wherein at least one end-plate is applied to the handle of the interengaged arm, in particular two end-plates, the or each end-plate being applied to a side of the handle of the interengaged arm.

13. Interengaged multiple-grip set of pliers according to claim 1, wherein the articulation joint further comprises a shaft which extends along the axis of the member of the joint, relative to which shaft the interengaging arm pivots, with the shaft being laterally displaced by d relative to the axis of the elongate opening.
